(19) United States
(12) Patent Application Publication
(10) Pub. No.: US 2020/0375239 A1
(43) Pub. Date: Dec. 3, 2020

(54) APPARATUS AND METHOD FOR RECOVERING POMACE

(71) Applicant: Tropicana Products, Inc., Bradenton, FL (US)

(72) Inventors: Jeffrey D. Mathews, Naperville, IL (US); Jin-E Shin, Hoffman Estates, IL (US); Isaac Arzuaga, Palmetto, FL (US)

(21) Appl. No.: 16/426,937

(22) Filed: May 30, 2019

(51) Int. Cl. A23N 1/00; A23N 1/02; A23L 19/00

(52) U.S. Cl. CPC A23N 1/003; A23V 2002/00; A23L 19/07; A23N 1/02

(57) ABSTRACT

A method for recovering pomace from a citrus fruit includes providing the citrus fruit to an extractor that separates the fruit into three primary product streams, (i) pomace, juice and pulp, (ii) seeds, peel caps, and peel frits, (iii) waste peel. The extractor includes a vertically oriented strainer tube with axially oriented slots, i.e., slots parallel to the longitudinal axis of the strainer tube, to effectively separate pomace, juice and pulp from the other two primary product streams. An apparatus for performing the method is described.

The invention relates to an improved apparatus and method for recovering pomace generated during the processing of whole fruits and vegetables. More particularly, the invention relates to an apparatus and methods for recovering from citrus fruits pomace that is substantially free of seeds and peel.

### BACKGROUND

Whole vegetables and fruits are generally not used for human consumption because they contain ingredients such as skins, seeds, stems, roots, and the like. Instead, juices and/or pulp are obtained from the vegetables and fruits with the skins, seeds, stems, roots, and the like discarded. These discarded ingredients are often in the form of pomace.

Pomace typically refers to the pulpy edible by-product remaining after fruit or vegetable juice pressing processes, wine crush operations, puree and concentrate operations, canning processes, and other food manufacturing processes. Pomace may include, for example, skins, pulp, and other edible parts of the fruit and vegetable such as apples, oranges, or carrots.

For example, in the processing of citrus fruits, a juice extractor of a type shown in U.S. Pat. No. 5,996,485 may be used. In this type of juice extractor, a citrus fruit, such as an orange, is initially fed into a bottom cup by a cam-operated feeding device, which deposits the fruit in the bottom cup. The upper cup then descends into the lower cup. The fruit is pressed against sharp circular cutters positioned at the top of a strainer tube adjacent the lower cup, and an upper cutter positioned in the upper cup. The two circular cutters cut plugs into both the top and bottom portions of the fruit as the interdigitating fingers of the two cups mesh together. At the same time, the inner portions of the fruit (i.e., the pulp and juice) are forced down into the strainer tube positioned within a manifold. The peeled surfaces of the fruit do not contact the juice as the interdigitating fingers peel the fruit. After the upper cup has descended toward the lower cup, an orifice tube moves upward into the strainer tube. The orifice tube includes a restrictor in its lower end. The orifice tube applies pressure into the internal portion of the strainer tube, which contains a number of holes, to separate juice and pulp within the strainer tube, collect the core material and discharge the core material out of the bottom of the orifice tube. The core material typically includes the membrane, seeds, and peel plugs.

A potential disadvantage with this type of extractor is that the pomace, which includes the membrane, cannot be easily separated from the seeds and peel plugs. As a result, the pomace, seeds, and peel plugs are typically considered waste product and are disposed of or used for non-human feed.

One solution to this problem is shown in U.S. Pat. No. 6,293,189 where the strainer tube with holes is replaced with a strainer tube having circumferential slots. The result is stated to provide a pulpier juice product because the longitudinal slots permit more of the desirable pulp to flow through the slots. While the described extractor achieves its desired result of providing a pulpier juice product, it also suffers the problem of retaining the pomace, including the membrane, seeds and peel plugs in one fraction, while separating into another fraction the juice and juice sacs (or pulp). As with the extractor described in U.S. Pat. No. 5,996,485, the pomace cannot be easily separated from the seeds and peel plugs.

Because pomace is composed primarily of water, carbohydrates, fiber, protein, fat as well as polyphenolic flavonoids and polymethoxylated flavones, it would be desirable to recover the pomace for use as a nutritional food product.

### SUMMARY

According to one aspect of the disclosure, a method is provided to recover pomace produced during the processing of whole fruits and vegetables, particularly citrus fruits. Citrus fruits include those fruits in the Rutaceae family as exemplified by orange, lemon, grapefruit, pomelo, lime, mandarin, and clementine.

The method includes delivering the citrus for processing, cleaning the citrus, grading the citrus, sizing the citrus for efficient extraction, extracting the juice and pomace from the citrus, separating the pomace from the juice, and further processing the pomace to provide a stable pomace product. In some aspects, the pomace separated from the juice contains less than about 100 ppm limonin, or less then about 50 ppm limonin, or less than about 10 ppm limonin, or less than about 5 ppm limonin, or less than about 1 ppm limonin.

In some instances, the extractor includes a lower cup for supporting a single piece of citrus fruit and an upper cup disposed vertically above the lower cup. The upper cup and lower cup are moveable relative to each other in a vertical direction so as to cooperate to squeeze the citrus fruit. The extractor includes an upper cutter for cutting a plug in the citrus fruit to permit the separation of the peel from the juice, pomace, seeds, and peel caps and a lower cutter for cutting a plug in the citrus fruit to allow the juice and to exit through the lower cutter. An elongated strainer tube is vertically oriented beneath the lower cup and lower cutter. The strainer tube has a longitudinal axis with a plurality of slots along at least a portion of its length and oriented parallel to the longitudinal axis to define solid space and free space. The plurality of slots are arranged circumferentially about the strainer tube. A plunger tube is slidingly received within the strainer tube for forcing the juice and pomace outwardly through the slots in the strainer tube into a separate reservoir while retaining the seeds and peel caps.

The slots in the strainer tube are axially oriented (i.e., oriented to be parallel to the longitudinal axis) and arranged circumferentially about the strainer tube. In addition, the slots are arranged in at least two rows along the working length of the strainer tube. The slots may have an axial length of about 2 mm to about 8 mm. The rows may be arranged such that slots in one row are aligned with slots in an adjacent row. Alternatively, the slots in one row may be offset from the slots in an adjacent row. The slots may have an equal width and may be evenly spaced apart or may have varying widths and the space between the slots may vary, so long as the openings are sized to retain the seeds and peel caps and to allow passage of the juice, pulp, and pomace. In some instances, the slots have a width (or opening) that is between about 0.79375 millimeters (mm) to about 3.175 mm in width and may be circumferentially spaced from each other, i.e., one slot is spaced from an adjacent slot in the same row a distance of about 6 mm to about 16 mm.

Unless otherwise explicitly noted, all percentages in this disclosure refer to a percent by weight.

### BRIEF DESCRIPTION OF THE DRAWINGS

The following description accompanies the drawings, all given by way of non-limiting examples that may be useful to understand how the described process and system may be embodied.

FIG. 1 is a general schematic flow sheet of a process for recovering pomace according to the present invention.

FIG. 2 is a perspective view of one embodiment of an automated juice extraction machine that is useful in the present process.

FIG. 3 is a fragmentary longitudinal view in partial cross-section of a single juice extracting mechanism.

FIG. 4 is a view similar to FIG. 3 showing the juice and pomace portions of the citrus being forced through the strainer tube and into a reservoir.

FIG. 5 is an enlarged perspective view of a strainer tube useful in one embodiment of an automated juice extractor that can be used in the present method.

### DESCRIPTION

Pomace refers to a natural by-product from the extraction of juices from fruits and vegetables and other processes. Pomace contains natural nutrients (such as vitamin A, vitamin C, vitamin E, anthocyanins, and antioxidants), flavors, and/or colors of the original fruits and vegetables. Pomace also contains high natural (un-processed) fibers.

In this specification, the term “pomace” means the solid remains of a pomaceous fruit or vegetable after pressing of the fruit or vegetable to extract the fruit or vegetable juice/fruit or vegetable puree from the or vegetable. The pomace contains the pulp of the fruit or vegetable, but not the seeds, stems and other non-edible parts of the fruit or vegetable which have been removed from the solid remains of the fruit or vegetable in an upstream separation process. The pomace is in the form of a solid pulp containing residual moisture from the fruit or vegetable.

Pomace may be obtained from any suitable fruit or vegetable such as, but not limited to, carrot, cranberry, orange, blueberry, tomato, apple, lemons, limes, grapes, strawberries, grapefruits, tangerine, mandarin orange, tangelo, pomelo, celery, beet, lettuce, spinach, cabbage, artichoke, broccoli, Brussels sprouts, cauliflower, watercress, peas, beans, lentils, asparagus, onions, leeks, kohlrabi, radish, turnip, rutabaga, rhubarb, carrot, cucumber, zucchini, eggplant, pineapple, peach, banana, pear, guava, apricot, watermelon, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, rowan, gooseberry, pomegranate, persimmon, mango, papaya, lychee, plum, prune, fig, or their combination. In certain instances, the pomace may also be obtained from any suitable citrus fruit. Citrus fruits include those fruits in the Rutaceae family as exemplified by orange, lemon, grapefruit, pomelo, lime, mandarin, and clementine.

The use of pomace in food products can fortify fiber and provide naturally existing nutrients such as vitamins and phytochemicals. Hence, it would be desirable to use pomace to provide an excellent natural and label-friendly way to enhance quality of food products including, for example, beverages, soups, spreads, puddings, smoothies and snacks.

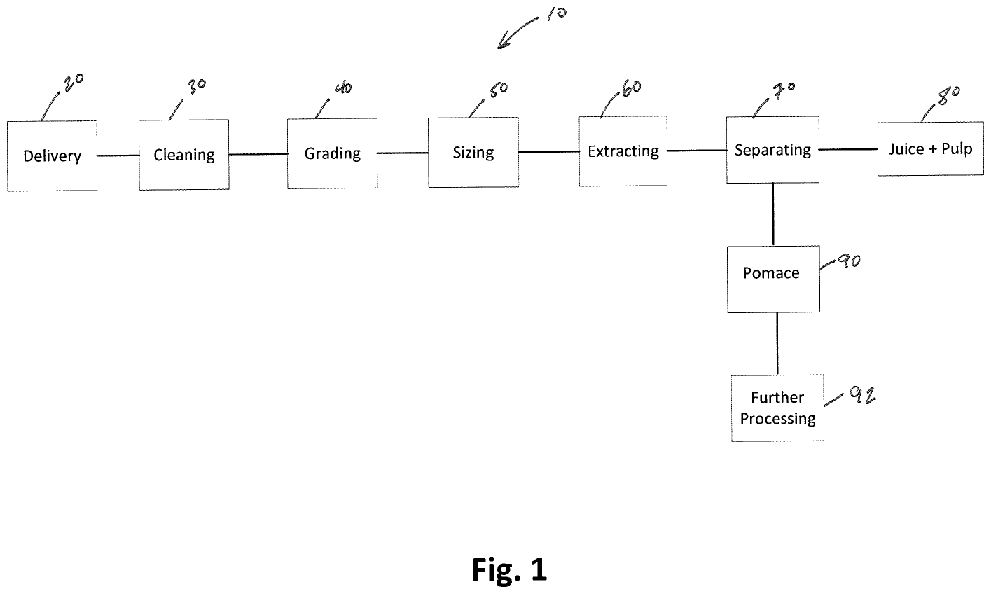

Turning now to FIG. 1, a general schematic of a process 10 to recover pomace is shown. In the following description, the process will be described in connection with citrus fruits and more particularly in connection with oranges, although as noted above, the process may be useful in recovering pomace from other fruits and vegetables.

Citrus fruit may be delivered 20 for processing after which the fruits may be cleaned 30 to help clean the exterior of the fruit from materials that might otherwise contaminate the juice, essential oils, and pomace. The cleaning may be accomplished using a brush washer where the fruit is scrubbed to remove field oils, soil, mold, and dust.

Thereafter, the citrus fruit may be graded 40 to remove foreign materials and unsuitable fruits. The grading may be accomplished using a roller grader where workers or automatic sorters select the fruit to remove broken pieces, leaves and other undesirable materials from the flow of fruit supply.

The citrus fruit is then sized 50 to separate the fruit according to the sizes that best match the extractors, i.e., to separate the fruit into sizes equivalent to the size range of the upper and lower cups of the individual extractor units in an effort to ensure the maximum yield and quality.

The sized fruit is directed to an appropriate extractor 60 which will produce three exit streams: (i) the peel, (ii) the juice, pomace, and pulp and (iii) the peel caps and seeds. Thereafter, the juice, pomace, and pulp fraction is collected and then the pomace 90 is separated 70 from the juice and pulp 80. The pomace 90 is collected and directed for further processing 92.

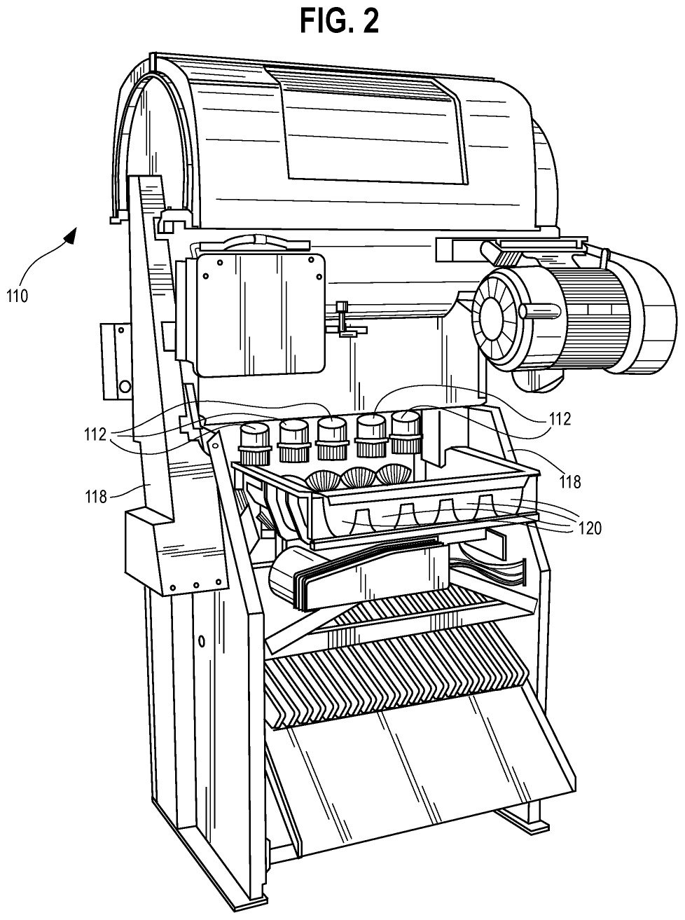

Turning now to FIG. 2 a juice extractor machine 100 useful in the method of the current invention is shown. In some embodiments, the juice extractor 100 includes five individual extractor units 112, each having an upper cup 114 and a lower cup 116, ganged together in a common frame 118. One of skill will understand that the juice extractor may include more or less than five individual extractor units 112. The individual fruits roll down the chutes 120 so that each piece of fruit will nest in the lower cup of the individual extractor units 112.

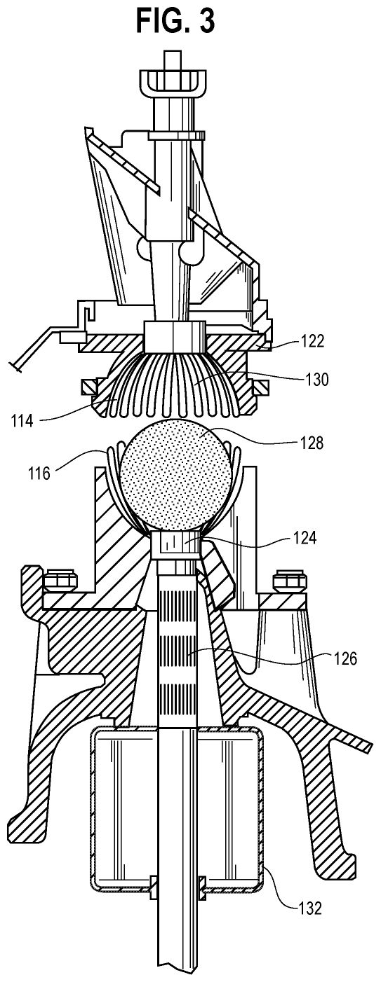

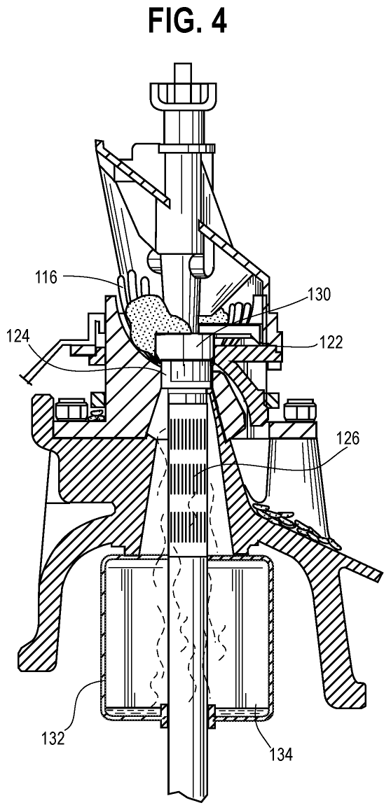

With reference now to FIGS. 3 and 4, an individual extractor unit 112 is shown with the upper and lower cups 114, 116, respectively. The upper cup 114 is supported on a cross bar 122 that moves in a fixed up and down direction by means of a cam-operated drive (not shown) contained in the top portion of the extractor machine 100. The lower cup 116 is rigidly positioned and secured to the frame 118.

As illustrated, the upper and lower cups 114, 116 are formed as interdigitated cups having fingers that intermesh together as the upper cup is moved into the lower cup. The cam-operated drive system forces the upper cup 114 into the lower cup 116 and presses the fruit against a circular cutter tube 124 located at the base of the lower cup 116 and on top of an elongated prefinishing or strainer tube 126. The cutter 124 cuts a plug in the bottom of the fruit 128 to allow the internal portions of the fruit access to the interior of the strainer tube 126.

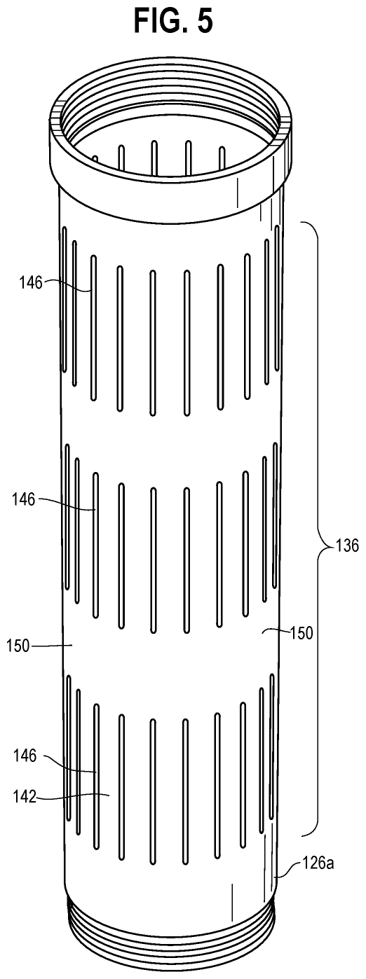

An upper cutter 130 is associated with the upper cup 114 and cuts a plug in the top of the fruit to permit separation of the peel from the internal portions of the fruit 128 as the fruit 128 is squeezed between the upper and lower cups 114, 116. The inner portion of the fruit 128 is forced down into the strainer tube 126 (FIG. 5), and a plunger tube (not seen) received on the interior of the strainer tube 126 moves upwardly to force the inner portions of the fruit 128 that are appropriately sized through the strainer tube and into a juice manifold or reservoir 132, where the juice, pulp, and pomace 90 are collected. The peel is discharged between the upper cup and upper cutter.

It has been determined that both the configuration and the orientation of the strainer tube 126 affects the recovery of the pomace extracted from the fruit. Specifically, it has been found that a vertically oriented strainer tube 126 having a plurality of axially oriented slots 146 (i.e., slots arranged parallel to the longitudinal axis of the strainer tube 126) along its working length provides excellent recovery of pomace that is free of contamination from peel caps and seeds. This is believed to occur because the combination of axially oriented slots 146 and vertical orientation results in enhanced pomace collection volumes, as well as juice and pulp collection volumes, free of contamination from peel caps and seeds as the pomace (and juice and pulp) passes through the strainer tube 126.

Referring more specifically to the strainer tube 126 shown in FIG. 5, it has a working length 136 along which the axially oriented slots 146 are positioned. The working length 136 has both solid space 142 and 150 and open or free space 146 (i.e., slots). In the illustrated embodiments, the free space is in the form of axial slots 146, and the solid space is in the form of metal or polymer land areas (i.e., solid space or land areas) 142 and 150 between the slots.

With further reference to FIG. 5, an embodiment of the strainer tube 126 is shown. The strainer tube 126 includes a plurality of axially oriented slots 146 (slots oriented parallel to the longitudinal axis of the strainer tube) arranged circumferentially about the strainer tube 126 and along its working length 136. The axially oriented slots 146 are generally provided circumferentially about the entire periphery of the strainer tube 126 or at least a substantial portion of the entire periphery of the strainer tube 126.

As noted above, adjacent slots 146 are spaced from each other to define a land area or solid space 142. The distance between adjacent slots is from about 0.5 mm to about 6 mm and in some instances from and in some instances from about 0.5 mm to about 3 mm.

In addition, the slots 146 are arranged in at least two rows along the working length 136 of the strainer tube 126. The rows are spaced from each other a distance that ranges between about 0.5 mm to about 16 mm. The rows may be aligned or offset. The rows may be arranged such that slots 146 in one row are aligned with slots 146 in an adjacent row. Alternatively, the slots 146 in one row may be offset from the slots 146 in an adjacent row.

As illustrated in FIG. 5, the axial length of the slots 146 is equal and the rows of slots 146 are evenly spaced by the circumferential land areas 142. It will be appreciated that the axial length of the slots 146 may differ and the width of the circumferential land areas 142 may differ, although in practice it may be desirable if the axial lengths and widths of the slots 146 were equal and the width of the circumferential land areas 142 were equal. In some instances, the axial length of the slots 146 is between about 2 mm to about 8 mm. The width of the circumferential land areas may be between about 0.5 mm to about 3 mm.

As illustrated, the width of the slots 146 is equal, and the slots 146 are evenly spaced by the axially oriented land areas 142 along the working portion of the strainer tube 126. It should be appreciated that the width of the slots 146 may differ. In practice, the width of the slots is between approximately 0.79375 mm to about 3.175 mm. In some instances, the width of the slots is between approximately 1.5875 mm to about 2.38125 mm Slot widths and land widths can vary along the working length.

Advantageously, the orientation, configuration, and size of the slots 146 in the strainer 126 are effective to retain seeds and peel caps while allowing juice and pomace to pass.

As noted above, the pomace, juice, and pulp are collected in a juice manifold or reservoir 132, where they can be directed to a separator to separate the pomace 90 from the juice and pulp 80.

In some aspects, the pomace separated from the juice contains less than about 100 ppm limonin, or less then about 50 ppm limonin, or less than about 10 ppm limonin, or less than about 5 ppm limonin, or less than about 1 ppm limonin. The separated pomace can be directed for further processing 100 to provide a stabilized pomace product.

While the concepts of the present disclosure are susceptible to various modifications and alternative forms, specific exemplary embodiments of the disclosure have been shown by way of example in the drawings. It should be understood, however, that there is no intent to limit the concepts of the present disclosure to the particular disclosed forms; the intention is to cover all modifications, equivalents, and alternatives falling within the spirit and scope of the invention as defined by the claims.

1. A method for recovering pomace from a citrus fruit comprising:
providing the citrus fruit to an extractor that comprises:
a lower cup for supporting a single piece of citrus fruit;
an upper cup disposed vertically above the lower cup, the upper and lower cups moveable relative to each other in a vertical direction so as to cooperate to squeeze the citrus fruit;
an upper cutter for cutting a plug in the citrus fruit to permit the separation of the peel from the juice and juice sacs;
a lower cutter for cutting a plug in the citrus fruit to allow the juice and juice sacs to exit through the lower cutter;
an elongated strainer tube vertically oriented beneath the lower cup and lower cutter, the strainer tube having a plurality of slots along at least a portion of its length and axially oriented to define solid space and free space;
a plunger tube slidingly received within the strainer tube for forcing juice and pomace outwardly through the slots in the strainer tube into a separate reservoir while retaining seeds and peel caps; and, separating the pomace from the juice.

2. The method of claim 1 wherein each slot comprises an open area and at least one land.

3. The method of claim 1 wherein lands of adjacent slots are displaced from each other.

4. The method of claim 1 wherein the slots in the strainer tube are of equal width and evenly spaced apart.

5. The method of claim 1 wherein the slots in the strainer tube are between about 0.79375 mm to about 3.175 mm millimeters in width.

6. The method of claim 1 wherein the slots in the strainer vary in width.

7. The method of claim 1 wherein the slots are arranged circumferentially about the strainer tube and arranged in at least two rows.

8. The method of claim 7 wherein the slots in the at least two rows are aligned.

9. The method of claim 1 further comprising processing the pomace to provide a stabilized pomace product.

10. An apparatus for recovering pomace from a citrus fruit comprising:
a lower cup for supporting a single piece of citrus fruit;
an upper cup disposed vertically above the lower cup, the upper and lower cups moveable relative to each other in a vertical direction so as to cooperate to squeeze the citrus fruit;
an upper cutter for cutting a plug in the citrus fruit to permit the separation of the peel from the juice and juice sacs;
a lower cutter for cutting a plug in the citrus fruit to allow the juice and juice sacs to exit through the lower cutter;
an elongated strainer tube vertically oriented beneath the lower cup and lower cutter, the strainer tube having a plurality of slots along at least a portion of its length and axially oriented to define solid space and free space; and
a plunger tube slidingly received within the strainer tube for forcing juice and pomace outwardly through the slots in the strainer tube into a separate reservoir while retaining seeds and peel caps.

11. The apparatus of claim 10 wherein each slot comprises an open area and at least one land.

12. The apparatus of claim 10 wherein lands of adjacent slots are displaced from each other.

13. The apparatus of claim 10 wherein the slots in the strainer tube are of equal width and evenly spaced apart.

14. The apparatus of claim 10 wherein the slots in the strainer tube are between about 0.79375 mm to about 3.175 mm millimeters in width.

15. The apparatus of claim 10 wherein the slots in the strainer vary in width.

16. The apparatus of claim 10 wherein the slots are arranged circumferentially about the strainer tube and arranged in at least two rows.

17. The apparatus of claim 10 wherein the slots in the at least two rows are aligned.
